(19) United States
(12) Patent Application Publication
(10) Pub. No.: US 2014/0035459 A1
(43) Pub. Date: Feb. 6, 2014

(54) PORTABLE ILLUMINATION DEVICE WITH ADJUSTABLE DIMMER

(71) Applicants: Gregory David Windom, Portland, OR (US); Jun Fang, Zhuhai (CN)

(72) Inventors: Gregory David Windom, Portland, OR (US); Jun Fang, Zhuhai (CN)

(73) Assignee: Coast Cutlery Company, Portland, OR (US)

(21) Appl. No.: 13/567,249

(22) Filed: Aug. 6, 2012

(51) Int. Cl. H05B 37/02

(52) U.S. Cl. 315/33

(57) ABSTRACT

Portable illumination devices (e.g., flashlights, headlamps, mobile devices with lights, watches, etc.), assemblies and methods of use are described herein. In various embodiments, a portable illumination device may include a housing, a light source, a Hall Effect sensor, a magnet that is movable relative to the Hall Effect sensor and provides a magnetic field, and a logic contained within the housing. In various embodiments, the logic may be operably coupled to the light source and the Hall Effect sensor. In various embodiments, the logic may be configured to alter a quantity of light emitted by the light source based on data, provided by the Hall Effect sensor, indicative of a spatial relationship between the magnet and the Hall Effect sensor.

### TECHNICAL FIELD

Embodiments of the present invention relate to portable illumination devices such as flashlights and headlamps.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Portable illumination devices such as flashlights or headlamps may include light sources that may be capable of emitting varying amounts of light. However, mechanisms for controlling the amount of light emitted by such a light source may bulky. This may lead to portable illumination devices themselves being too bulky or heavy. Moreover, many such mechanisms are vulnerable to damage from moisture or other elements.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a perspective view of a portable illumination device, in accordance with various embodiments.

FIG. 2 is a front view of the portable illumination device of FIG. 1, in accordance with various embodiments.

FIG. 3 is a perspective view of the portable illumination device of FIGS. 1-2, with a tiltable lens housing tilted down, in accordance with various embodiments.

FIG. 4 is an exploded view of the portable illumination device of FIGS. 1-3, in accordance with various embodiments.

FIG. 5 is a perspective view of a portable illumination device of FIGS. 1-4 next to a battery back, in accordance with various embodiments.

FIGS. 6 and 7 schematically depict a magnetic field produced by two magnets relative to a Hall Effect sensor, in accordance with various embodiments.

FIG. 8 schematically depicts example logical components that may be incorporated into portable illumination devices such as that shown in FIGS. 1-4, in accordance with various embodiments.

### DETAILED DESCRIPTION OF VARIOUS EMBODIMENTS

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

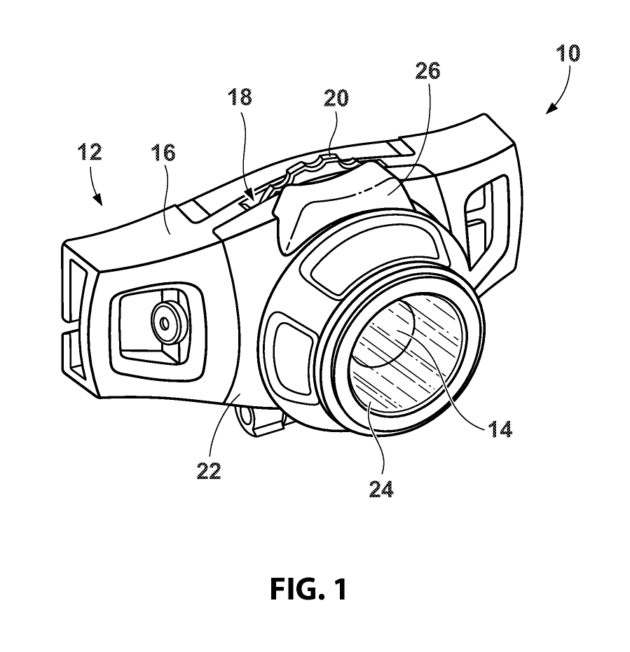

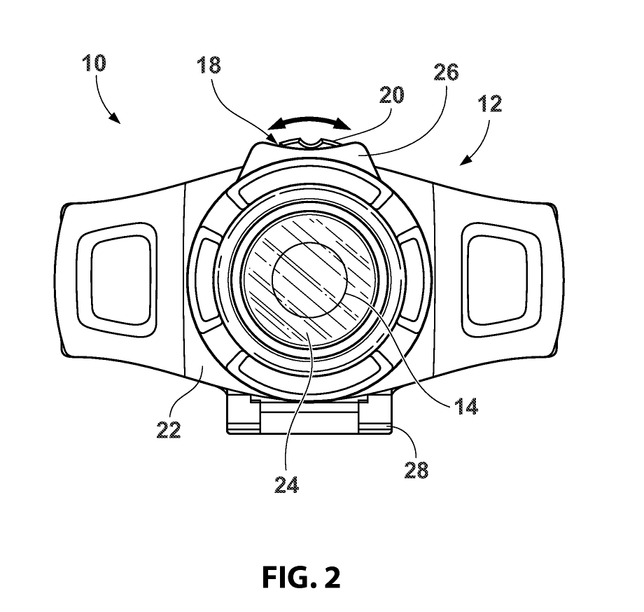

Referring now to FIGS. 1 and 2, a portable illumination device 10 may include a housing 12 and a light source 14. Light source 14 may be various types of light sources, including but not limited to an incandescent light bulb, a light-emitting diode (“LED”), and so forth. Although the drawings depict portable illumination device 10 as a headlamp, this is not meant to be limiting. Disclosed techniques may be equally applicable to other types of portable illumination devices, including but not limited to flashlights, key chains with mini flashlights, mobile devices such as smart phones, tablet computers or cameras with dimmable light sources, and so forth. [Greg—we include this paragraph and the broadest claims in order to capture as much of the market as possible. If we limit coverage to a head lamp, our chance of protection might be a little greater but the patent would be narrower. Let's discuss.]

Housing 12 may include various compartments. Some compartments may be partially or completed closed off, and may be water-resistant or waterproof to house components that may be sensitive to moisture or other elements. Other compartments may not be entirely closed off, and may hold components that are not sensitive to water or other elements. The embodiment shown in the drawings includes a water-resistant compartment 16 and another compartment 18. A rotating member such as a wheel 20 is mounted partially within compartment 18. Wheel 20 is rotatable in the direction indicated by the arrow in FIG. 2 to adjust an amount of light emitted from light source 14, as will be discussed below.

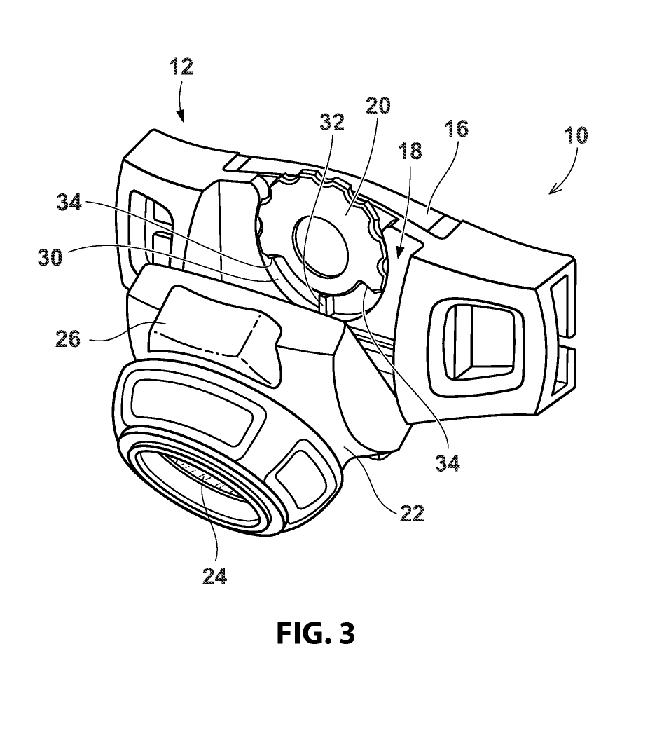

In various embodiments, portable illumination device 10 may include one or more components that may be adjustable to point light in various directions. For example, and as best shown in FIG. 3, portable illumination device 10 includes a tiltable lens housing 22 that includes a lens 24, light source 14 and an actuator 26. In various embodiments, and as best seen in FIG. 2, tiltable lens housing 22 is mounted to housing 12 with a hinge 28. As shown in FIG. 3, tiltable lens housing 22 may be tilted about hinge 28 to point lens 24 and light source slightly downward, e.g., at a book or map being read by a user.

In various embodiments, actuator 26 may be operated by a user to turn light source 14 on and off. In some embodiments, actuator may further be operated to cause light source 14 to emit light for various time intervals (e.g., flashing or other patterns). For example, when light source 14 is off, a user may press actuator 26 a first predetermined number of times (e.g., once) to turn light source 14 on, and a second predetermined number of times (e.g., twice) to cause light source 14 to blink on and off, e.g., rapidly. In various embodiments, a user may press actuator 26 a third predetermined number of times to turn light source 14 off

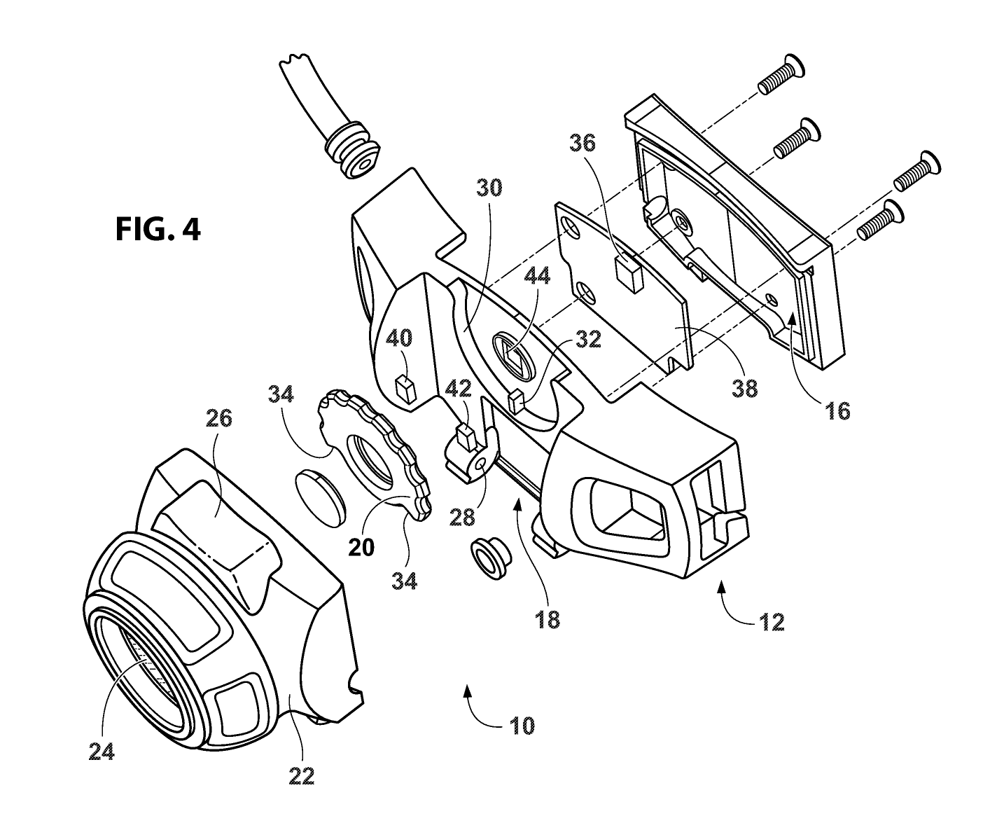

FIG. 4 is an exploded view of portable illumination device 10 of FIGS. 1-3. This view demonstrates how various internal components may be assembled. A circular recess 30 is defined within the another compartment 18. Wheel 20 is mounted in and rotatable within circular recess 30. Circular recess 30 includes a stop member 32, which may limit rotation of wheel 20. Wheel 20 may include abutment edges 34 configured to abut stop member 32 when wheel 20 is rotated beyond a particular degree in either direction.

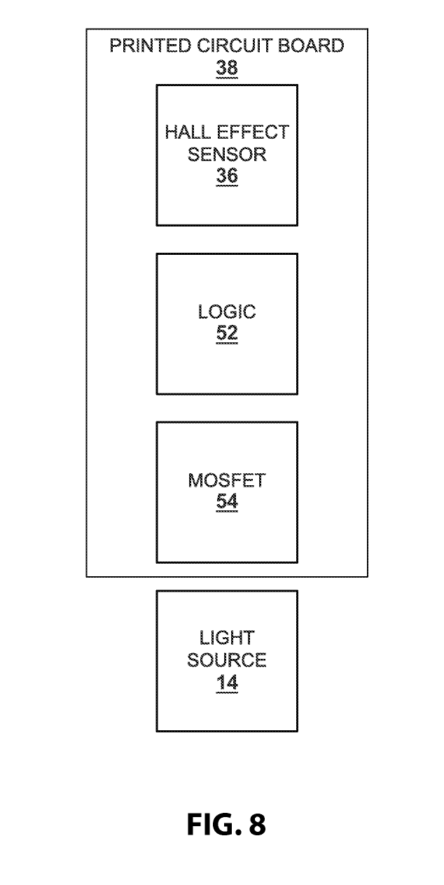

Within water-resistant compartment 16, a Hall Effect sensor 36 is mounted on a printed circuit board (“PCB”) 38. Hall Effect sensor 36 may be operably coupled to logic (see FIG. 8) that may also be mounted or contained on PCB 38. In various embodiments, the logic may be a microprocessor or an application-specific integrated circuit (“ASIC”). In various embodiments, Hall Effect sensor 36 may have various dimensions to accommodate various sizes of portable illumination devices. For instance, in some embodiments, Hall Effect sensor 36 may be approximately 2 mm thick. In some embodiments, Hall Effect sensor 36 may be a Triaxis™ Non-Contact Position Sensor, e.g., model no. MLX90360.

In various embodiments, one or more magnets that provide one or more magnetic fields may be mounted on movable components so that they may be moved relative to Hall Effect sensor 36. For example, in FIG. 4, a first magnet 40 and a second magnet 42 are mounted on wheel 20. When wheel 20 is rotated within circular recess 30, first magnet 40 and second magnet 42 are likewise rotated. When portable illumination device 10 is fully assembled, all or a portion of Hall Effect sensor 36 may extend through a pass through 44. Thus, even though first magnet 40 and second magnet 42 are contained in a separate compartment, they may occupy a similar plane as Hall Effect sensor 36. For example, in the embodiment of FIGS. 1-4, first magnet 40 and second magnet 42 are on the same plane as and flank Hall Effect sensor 36 on each side.

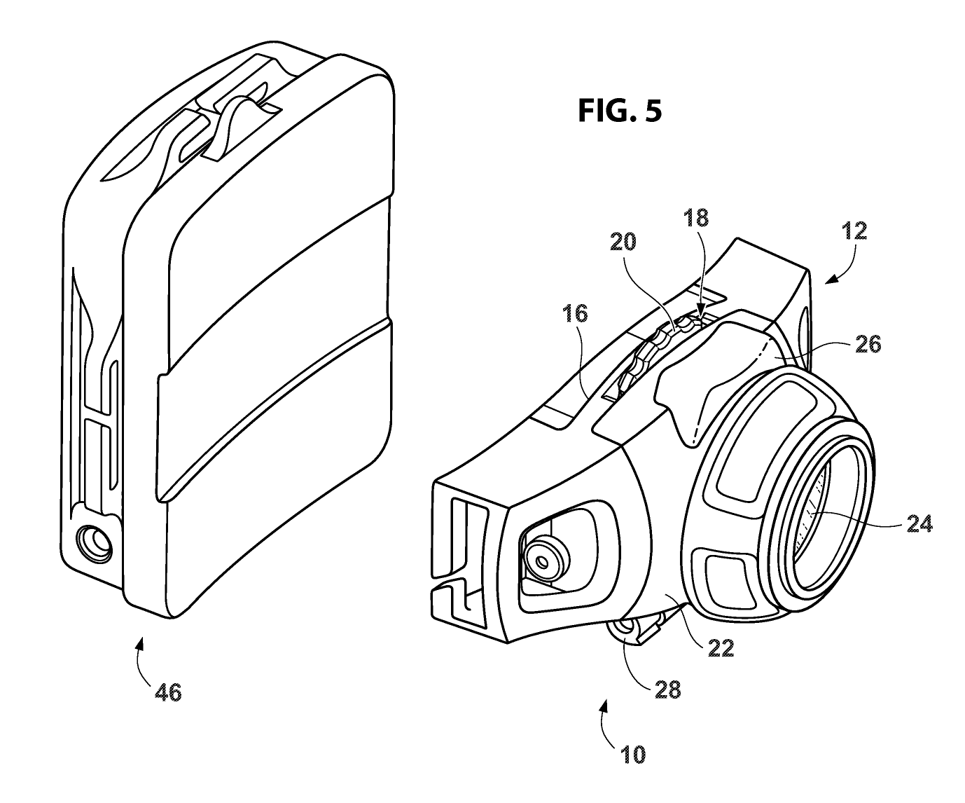

In various embodiments, Hall Effect sensor 36 and other components mounted on PCB 38, as well as other components such as light source, may be powered by a power source such as a battery. FIG. 5 depicts an example battery pack 46 that may be secured to portable illumination device 10, e.g., using an adjustable headband (not shown). In various embodiments, battery pack 46 may include controls that may be used to control aspects of portable illumination device 10. In other embodiments, battery pack 46 may only house batteries, and control of portable illumination device 10 may be implemented via other components, such as actuator 26 and/or wheel 20.

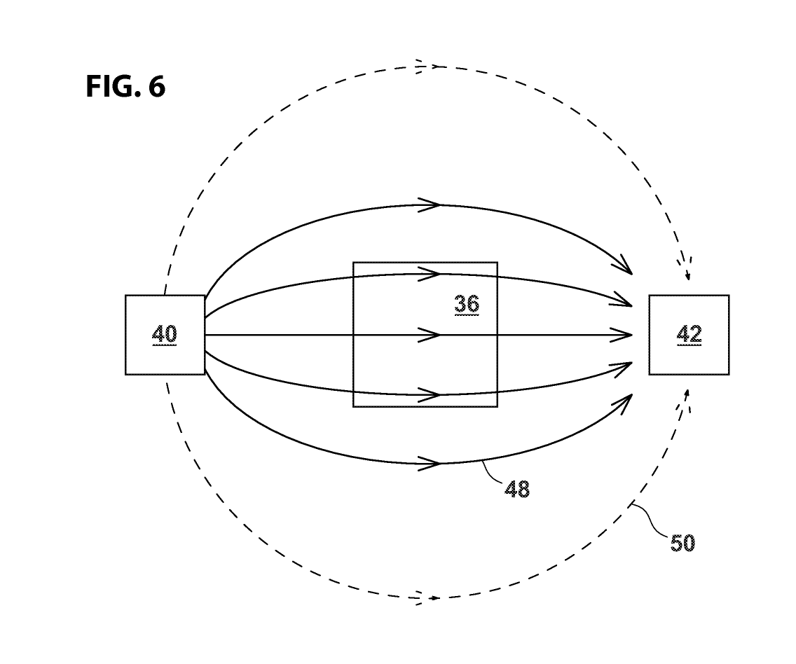

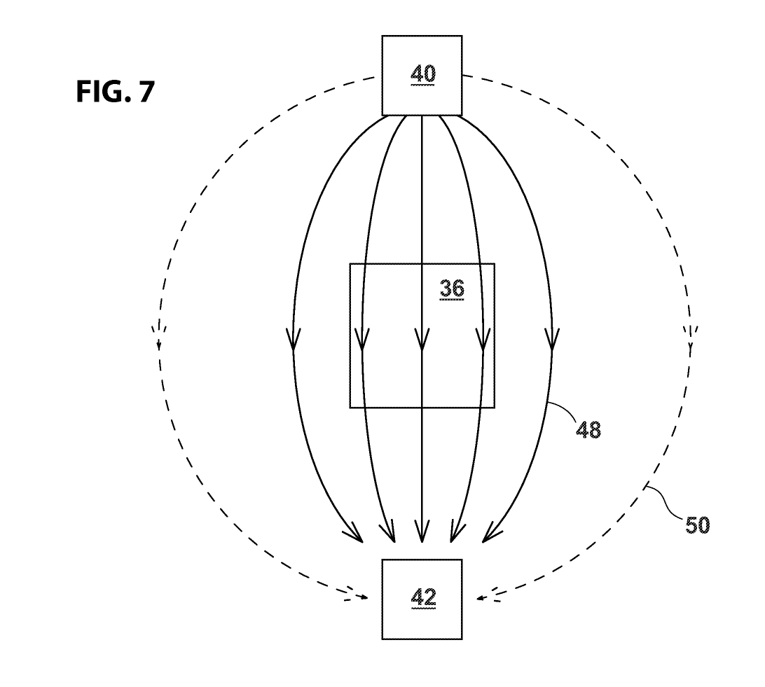

FIGS. 6 and 7 depict schematically an example of how a spatial relationship between first and second magnets 40, 42 and Hall Effect sensor 36 may be changed, which in turn may cause light source 14 to emit varying amounts of light. In FIG. 6, first magnet 40 is to the left of Hall Effect sensor 36 and second magnet 42 is to the right of Hall Effect sensor 36. First magnet 40 and second magnet 42 are aligned so that their north poles (not shown) are on the right side of each magnet in FIG. 6 and on the bottom side of each magnet in FIG. 7. Their south poles are on the left side of each magnet in FIG. 6 and on the top side of each magnet in FIG. 7. This alignment forms a magnetic field 48 as shown in FIGS. 6 and 7, from the north pole of first magnet 40 to the south pole of second magnet 42. Magnetic field 48 is not limited to the field lines shown; other field lines are omitted for the sake of clarity. While two magnets are shown in various embodiments, this is not meant to be limiting. In other embodiments, a single magnet may be used, or more than two magnets may be used. In some embodiments, one or more magnets may not necessarily be on a same plane as or flank Hall Effect sensor 36. For example, a single magnet could be rotatably mounted on top of Hall Effect sensor 36, although that would cause the whole assembly to be thicker.

As described above, first magnet 40 and second magnet 42 are mounted to wheel 20 so that they may be rotated partially or completely about a circular path 50 that encircles Hall Effect sensor 36. For example, in FIG. 7, the magnets have been rotated from their positions of FIG. 6 so that first magnet 40 is above Hall Effect sensor 36 and second magnet 42 is below Hall Effect sensor 36. This rotation of the magnets also rotates magnetic field 48. The change in orientation of magnetic field 48 may be detected by Hall sensor 36.

FIG. 8 schematically depicts example circuit components that may be utilized in a portable illumination device such as portable illumination device 10 of FIGS. 1-4. Hall Effect sensor 36 may operably coupled to a logic 52, e.g., via PCB 38. As noted above, logic 52 may be a microprocessor, an ASIC, software executing on a processor, and so forth. In various embodiments, logic 52 may be operably coupled to light source 14 directly or indirectly. For instance, in FIG. 8, logic 52 is operably connected to a metal-oxide-semiconductor field-effect transistor (“MOSFET”) 54. In various embodiments, logic 52 may be configured to adjust a resistance of MOSFET 54 to control a current applied to light source 14, based on data provided by Hall sensor 36 to logic 52.

Various components of portable illumination device may be mounted on PCB 38. For instance, in FIG. 8, Hall Effect sensor 36, logic 52 and MOSFET 54 are mounted to PCB 38. However, this is for example only, and any components may be mounted to PCB 38.

In various embodiments, logic 52 may be configured to cause light source 14 to emit a medium or nominal amount of light when first magnet 40 and second magnet 42 are aligned as shown in FIG. 6. When the magnets are so aligned, wheel 20 may be rotated to a position approximately midway between one abutment edge 34 and the other abutting edge contacting stop member 32. If wheel 20 is rotated one way or the other until an abutment edge 34 abuts stop member 32, then first magnet 40 and second magnet 42 may be aligned as shown in FIG. 7, with magnetic field 48 similarly rotated relative to FIG. 6. This change in orientation may be detected by Hall Effect sensor 36 and reported to logic 52. Logic 52 in turn may cause light source 14 to emit an amount of light proportional to the amount of rotation.

Hall Effect sensor 36 may be configured to provide information indicative of a spatial relationship between the magnets and Hall Effect sensor 36. For instance, Hall Effect sensor 36 may detect an absolute or relative orientation of magnet field 48, and provide data indicative of the orientation to logic 52. Based on this information, logic 52 may cause light source 14 to emit an amount of light that is in some way proportional to the amount of this rotation. For example, if magnetic field 48 is aligned as shown in FIG. 6, logic 52 may apply approximately 50% power (or another percentage of power that yields a nominal amount of light suitable for most purposes). If magnetic field 48 is aligned as shown in FIG. 7, logic 52 may apply closer to 100% power (or 0% power, depending on the configuration).

In various embodiments, Hall Effect sensor 36 may be configured to provide information indicative of other characteristics of spatial relationships between the magnets and Hall Effect sensor 36. For instance, in some embodiments, Hall Effect sensor 36 may detect a magnitude of a voltage difference across a conductor of Hall Effect sensor 36 caused by magnetic field 48. Logic 52 may adjust an amount of light emitted by light source 14 in proportion to this magnitude.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A portable illumination device, comprising:
a housing;
a light source;
a Hall Effect sensor;
a magnet that is movable relative to the Hall Effect sensor and provides a magnetic field; and
a logic contained within the housing and operably coupled to the light source and the Hall Effect sensor, the logic being configured to alter a quantity of light emitted by the light source based on data, provided by the Hall Effect sensor, indicative of a spatial relationship between the magnet and the Hall Effect sensor.

2. The portable illumination device of claim 1, wherein the spatial relationship comprises an orientation of a magnetic field of the magnet relative to the Hall Effect sensor.

3. The portable illumination device of claim 1, wherein the spatial relationship comprises a magnitude of a voltage difference across a conductor of the Hall Effect sensor caused by a magnetic field of the magnet.

4. The portable illumination device of claim 1, wherein the spatial relationship comprises a position of the magnet relative to the Hall Effect sensor.

5. The portable illumination device of claim 1, wherein the housing comprises a water-resistant compartment that contains the logic.

6. The portable illumination device of claim 5, wherein the housing includes another compartment separate from the water-resistant compartment that contains the magnet.

7. The portable illumination device of claim 1, wherein the magnet is a first magnet, and the device further comprises a second magnet, wherein the first and second magnets and the Hall Effect sensor are aligned on a plane.

8. The portable illumination device of claim 7, wherein the first and second magnets flank the Hall Effect sensor on the plane.

9. The portable illumination device of claim 8, wherein the first and second magnets are movable along a path encircling the Hall Effect sensor on the plane.

10. The portable illumination device of claim 1, wherein the magnet is mounted to a rotating member so that rotation of the rotating member causes the magnet to move along a circular path relative to the Hall Effect sensor.

11. The portable illumination device of claim 1, wherein the housing defines a headlamp, and the device further comprises a headband configured to secure the headlamp to a head of a user.

12. The portable illumination device of claim 1, wherein the housing defines a flashlight housing.

13. The portable illumination device of claim 1, wherein the logic is further configured to adjust a resistance of a MOSFET to control a current applied to the light source, based on the data provided by the Hall sensor.

14. The portable illumination device of claim 1, wherein the Hall Effect sensor is approximately 2 mm thick.

15. The portable illumination device of claim 1, further comprising a wheel on which the magnet is mounted, the wheel being positioned so that rotation of the wheel causes a magnetic field of the magnet to change its orientation relative to the Hall Effect sensor.

16. A light-dimming assembly for use with a portable illumination device comprising:
a Hall Effect sensor; and
a processor operably coupled to a light source of the portable illumination device and the Hall Effect sensor, the processor being configured to cause the light source to emit a quantity of light based on an orientation of a magnetic field provided by one or more movable magnets relative to the Hall Effect sensor.

17. The assembly of claim 16, further comprising a printed circuit board on which the Hall Effect sensor and processor are mounted.

18. A method of adjusting an amount of light emitted by a light source, comprising:
moving one or more magnets mounted on a portable illumination device relative to a Hall Effect sensor to alter a spatial relationship between the one or more magnets and the Hall Effect sensor;
operating the light source to emit a quantity of light based on the spatial relationship between the one or more magnets and the Hall Effect sensor.

19. The method of claim 18, wherein the spatial relationship comprises an orientation of a magnetic field of the one or magnets relative to the Hall Effect sensor.

20. The method claim 19, further comprising rotating a wheel on which the one or more magnets are mounted to cause the magnetic field to change its orientation relative to the Hall Effect sensor.
